(19) United States
(12) Patent Application Publication
(10) Pub. No.: US 2011/0197454 A1
(43) Pub. Date: Aug. 18, 2011

(54) Cutter

(76) Inventor: Min-Zheng ZENG, Taichung City (TW)

(21) Appl. No.: 12/707,673

(22) Filed: Feb. 17, 2010

(51) Int. Cl. B26B 5/00; B26B 1/08

(52) U.S. Cl. 30/162; 30/337

(57) ABSTRACT

A cutter includes a blade, a handle and a cassette. The handle includes a clipping unit including a space defined therein, at least one slot in communication with the space, and cutouts defined in an edge of the slot. The cassette includes a holder, a gate, a button and a key. The holder receives the blade except a tip. The holder is movably located in the space of the clipping unit. The gate is movably supported on the holder and used to keep the blade on the holder. The button is connected to the holder. The key is connected to the button and movable in and along the slot. The holder is retained in position relative to the clipping unit when the key is inserted in a selected one of the cutouts. The holder is movable relative to the clipping unit when the key is removed from the cutouts by pushing the button.

### BACKGROUND OF INVENTION

1. Field of Invention

The present invention relates to a cutter and, more particularly, to a device operable for holding a blade and for replacing the blade with a new blade.

2. Related Prior Art

As disclosed in Taiwanese Patent No. 1273957 for example, a cutter is provided with a device operable for replacing a blade with a new blade. The cutter includes a cassette and a gate movably located in the cassette to cassette the blade therein. The cassette is pivotally connected to a handle. Therefore, the gate is pivoted together with the cassette so that the blade can be withdrawn. The gate is pivoted for about 90 degrees so that the blade can be removed and replaced with the new blade.

The present invention is therefore intended to obviate or at least alleviate the problems encountered in prior art.

### SUMMARY OF INVENTION

It is the primary objective of the present invention to provide a cutter easily operable to hold and release a blade.

To achieve the foregoing objective, the cutter includes a blade, a handle and a cassette. The handle includes a clipping unit including a space defined therein, at least one slot in communication with the space, and cutouts defined in an edge of the slot. The cassette includes a holder, a gate, a button and a key. The holder receives the blade except a tip. The holder is movably located in the space of the clipping unit. The gate is movably supported on the holder and used to keep the blade on the holder. The button is connected to the holder. The key is connected to the button and movable in and along the slot. The holder is retained in position relative to the clipping unit when the key is inserted in a selected one of the cutouts. The holder is movable relative to the clipping unit when the key is removed from the cutouts by pushing the button.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a cutter according to the preferred embodiment of the present invention;

FIG. 2 is an exploded view of the cutter shown in FIG. 1;

FIG. 3 is a cross-sectional view of the cutter shown in FIG. 1;

FIG. 4 is a cross-sectional view of the cutter in another position than shown in FIG. 3;

FIG. 5 is an enlarged, partial, side view of the cutter shown in FIG. 4; and

FIG. 6 is a cross-sectional view of the cutter in another position than shown in FIG. 4.

### DETAILED DESCRIPTION OF PREFERRED EMBODIMENT

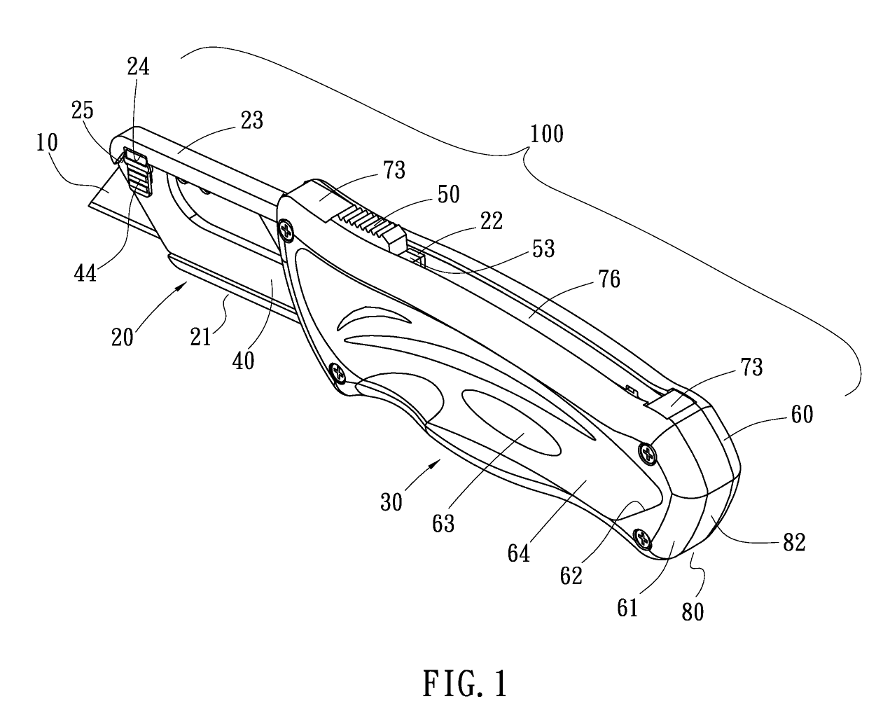

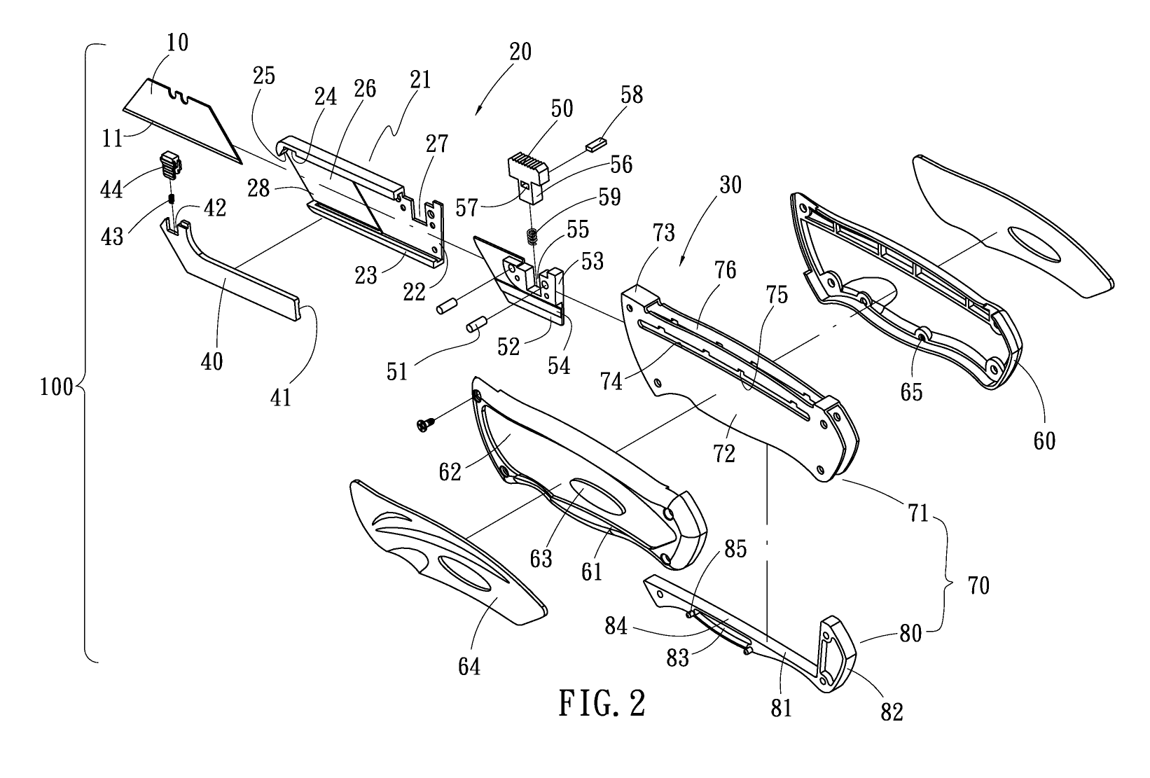

Referring to FIGS. 1 and 2, a cutter 100 includes a blade 10, a cassette 20 and a handle 30 according to the preferred embodiment of the present invention. The blade 10 includes a cutting edge 11 between two tips.

The cassette 20 includes a holder 21, a gate 40, a detent 44, a spring 43, a plate 52 and a button 50. The holder 21 includes a wall 22, upper and lower flanges 23 each extending along an edge of the wall 22, a recess 24 defined in the upper flange 23, a stop 25 extending from the upper flange 23, a cavity 26 defined in the wall 22, a cutout 27 defined in an upper edge of the wall 22, and a mouth 28 defined by the wall 22 and the upper and lower flanges 23. The cutout 27 is T-shaped.

The gate 40 is in the form of a plate with a groove 41 defined therein and a cutout 42 defined in an upper edge thereof. The gate 40 is used together with an detent 44 and a spring 43. The detent 44 is formed with a roof and two walls extending from the roof. One of the walls of the detent 44 is formed with a rough face for contact with a user's finger.

The button 50 is T-shaped corresponding to the cutout 27. The button 50 includes a lower section 56 extending vertically from a middle point of an upper section that extends horizontally. The upper section of the button 50 is formed with a rough upper surface for contact with a user's finger. A key 58 is inserted through a slot 57 defined in the button 50.

The plate 52 includes a thickened portion 53 and a cutout 55 defined in an upper edge of the thickened portion 53. The cutout 55 is T-shaped corresponding to the button 50. The plate 52 further includes a rib 54 extending on a side thereof below the thickened portion 53.

The handle 30 includes two shells 60 and 61 and a clipping unit 70. The clipping unit 70 includes a clipping element 71 and a pusher 80. The clipping element 71 includes two walls 72, front and rear roofs 73 extending between the walls 72, and a space 76 defined between the walls 72. Each of the walls 72 includes a slot 74 defined therein and several cutouts 75 defined in an edge of the slot 74.

The pusher 80 includes a body 81 and a tail 82 transversely extending from an end of the body 81. The body 81 includes a slot 83 defined in an enlarged portion thereof so that the enlarged portion is turned into an elastic portion 84. Two bosses 85 are formed on each side of the body 81.

Each of the shells 60 and 61 includes a cavity 62 defined in an external face thereof, an island 63 formed on the external face thereof within the cavity 62 and two recesses 65 defined in an external side. A soft decorative strip 64 is located in the cavity 62 of each of the shells 60 and 61 and attached to the external face of the same. Each of the soft decorative strips 64 includes an opening for receiving the island 63 of a related one of the shells 60 and 61.

Referring to FIGS. 1 through 3, the blade 10 is located in the cavity 26 except a selected one of the tips. The selected tip of the blade 10 is located outside the cavity 26 through the mouth 28. A portion of the blade 10 is located against the stop 25. An opposite portion of the blade 10 is located against a wall of the cavity 26 that is located opposite to the mouth 28. Thus, the blade 10 is not movable forwards or backwards relative to the holder 21.

Two pins 51 are inserted through two apertures defined in the thickened portion 53 of the plate 52 and fit in two apertures defined in the holder 21. Thus, the plate 52 is attached to the holder 21.

The roof of the detent 44 is movably located in the cutout 42. The spring 43 is compressed between the roof of the detent 44 and the upper edge of the gate 40 and confined between the walls of the detent 44. The gate 40 is located beside the blade 10 and the holder 21. The roof of the detent 44 is movably located in the recess 24. The groove 41 receives the rib 54 to ensure smooth sliding of the gate 40 relative to the holder 21 and the plate 52.

The button 50 is movably located in the cutouts 27 and 55. A spring 59 is compressed between the lower section 56 of the button 50 and the thickened portion 53 of the plate 52. The blade 10 and the cassette 20 are movably located in the space 76. The pins 51 are inserted through the slots 74 of the walls 72 of the clipping element 71 so that the cassette 20 is not pivotal relative to the handle 30. The pins 51 are movable in and along the slots 74 of the walls 72 of the clipping element 71. Each end of the key 58 is inserted through and movable in and along the slot 74 defined in a related one of the walls 72 of the clipping element 71. Each end of the key 58 can be located in a selected one of the cutouts 75 defined in a related wall 72 of the clipping element 71.

The pusher 80 is located between the walls 72 of the clipping element 71. The elastic portion 84 of the pusher 80 is located against the lower flange 23 of the holder 21.

The blade 10, the cassette 20 and the clipping unit 70 are located between the shells 60 and 61. The bosses 85 of the pusher 80 are fit in the recesses 65 of the shells 60 and 61. Fasteners such as pins, rivets and screws (not shown) are driven in the shells 60 and 61, the walls 72 of the clipping element 71 and the tail 82 of the pusher 80. Thus, the cassette 20 and the handle 30 are assembled.

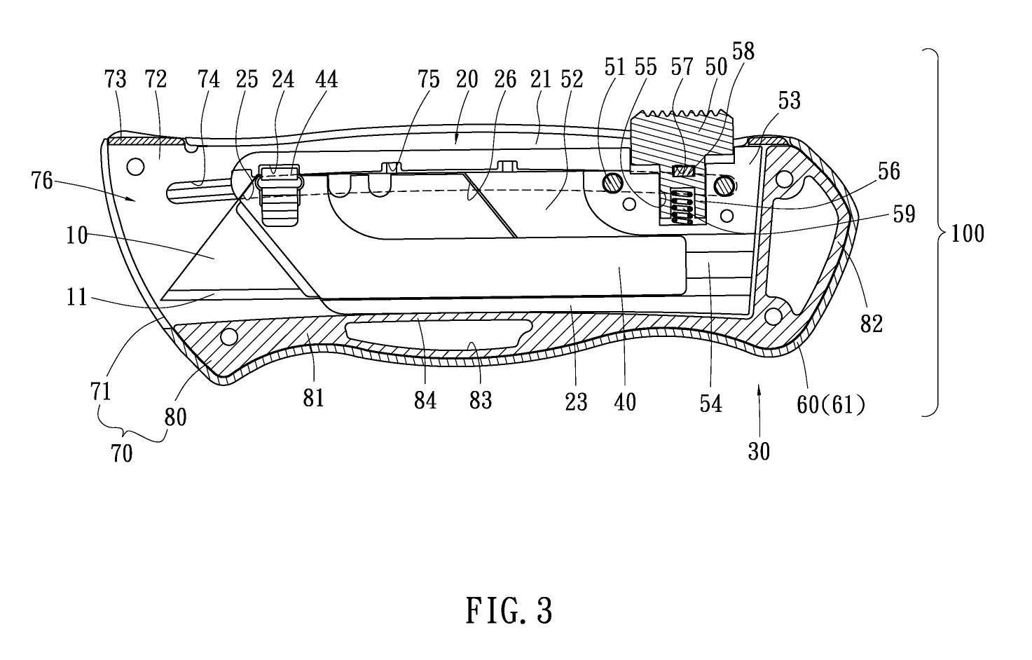

Referring to FIG. 3, the blade 10 is withdrawn in the handle. Due to the spring 59 compressed between the lower section 56 of the button 50 and the thickened portion 53 of the plate 52, each end of the key 58 is located in a selected one of the cutouts 75 defined in a related wall 72 of the clipping element 71. Thus, the cassette 20 is retained in position relative to the clipping unit 70. Hence, the blade 10 is retained in position.

By pushing the button 50, each end of the key 58 is removed from any one of the cutouts 75 defined in a related wall 72 of the clipping element 71. Thus, the cassette 20 is movable relative to the clipping unit 70. Accordingly, the blade 10 is movable.

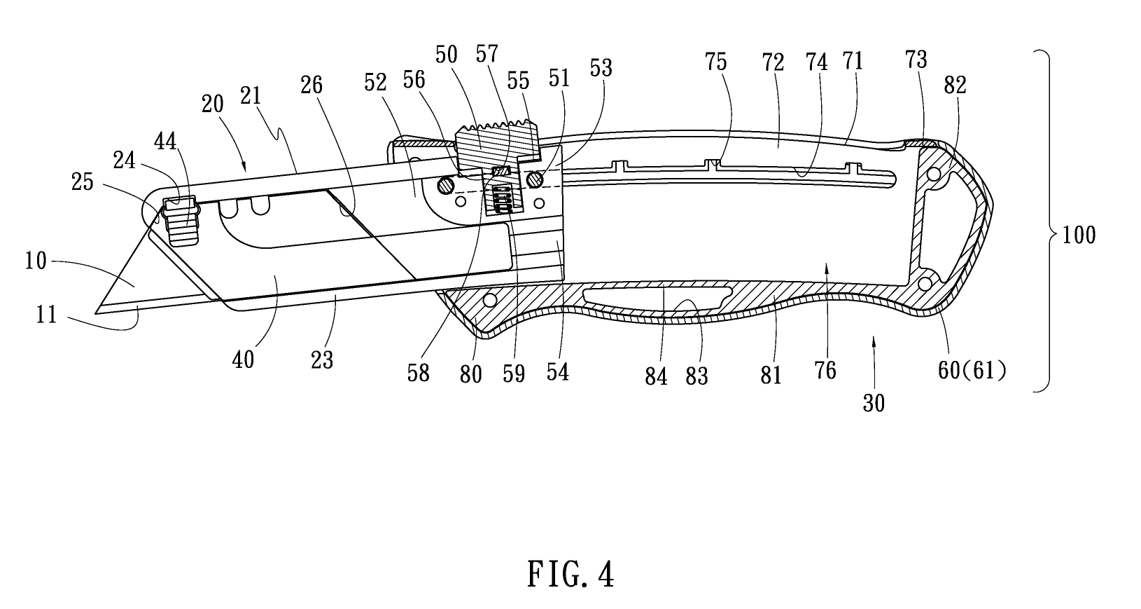

Referring to FIG. 4, the blade 10 is drawn from the handle. The button 50 is released. Due to the lower flange 23 of the holder 21 abutted against the elastic portion 84 of the pusher 80, each end of the key 58 is located in another one of the cutouts 75 defined in a related wall 72 of the clipping element 71. Thus, the cassette 20 is retained in position relative to the clipping unit 70 again. Hence, the blade 10 is retained in position again.

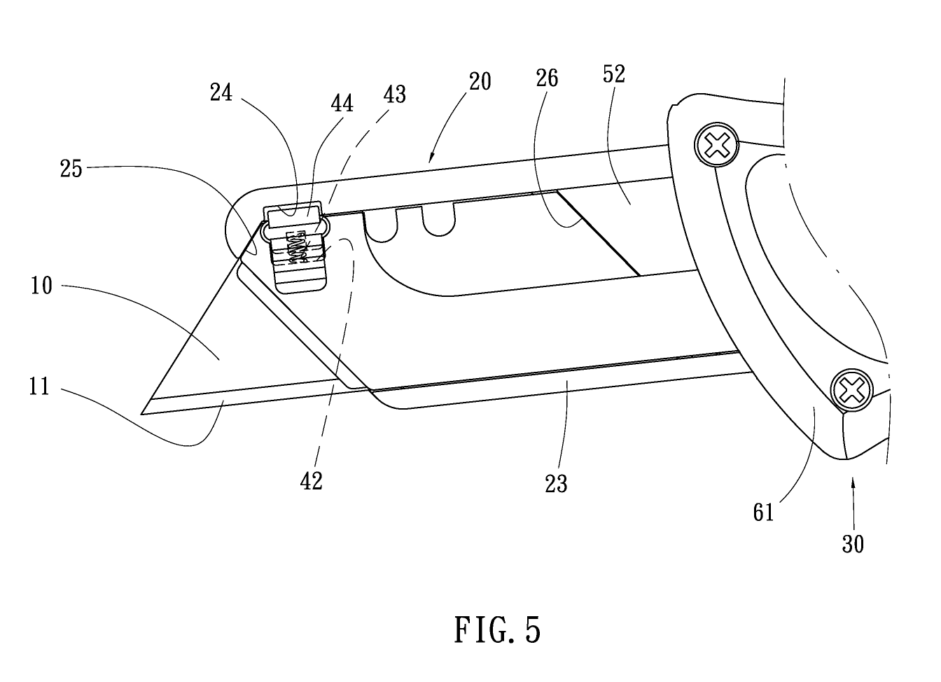

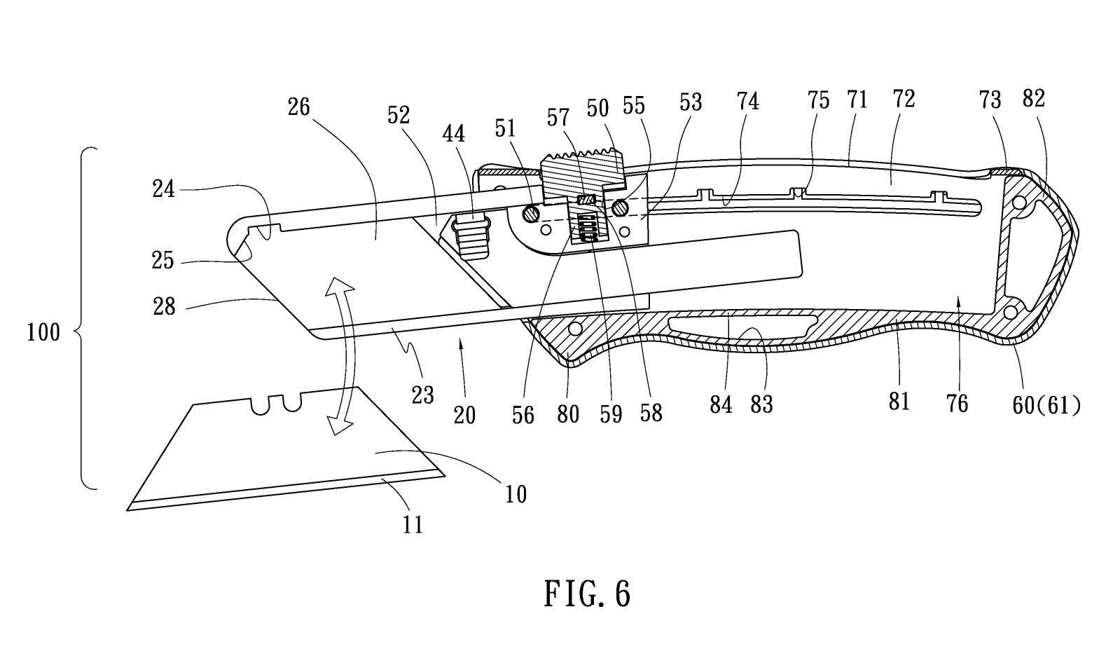

Referring to FIGS. 5 and 6, the detent 44 is removed from the recess 24. The gate 40 is removed backwards relative to holder 21 so that the cavity 26 is opened. The blade 10 is removed from the cavity 26. The blade 10 can be reversed and located in the cavity 26 again so that the other tip of the blade 10 is located outside the holder 21. Alternatively, the blade 10 can be replaced with a new blade.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A cutter comprising:
a blade;
a handle including a clipping unit including a space defined therein, at least one slot in communication with the space, and cutouts defined in an edge of the slot; and
a cassette including:
a holder for receiving the blade except a tip, wherein the holder is movably located in the space of the clipping unit;
a gate movably supported on the holder and used to keep the blade on the holder;
a button connected to the holder; and
a key connected to the button and movable in and along the slot,
wherein the holder is retained in position relative to the clipping unit when the key is inserted in a selected one of the cutouts, wherein the holder is movable relative to the clipping unit when the key is removed from the cutouts by pushing the button.

2. The cutter according to claim 1, wherein the cassette includes an detent movably connected to the gate, wherein the holder includes a wall, lower and upper flanges formed on the wall, and a recess defined in the upper flange, wherein the gate is supported on the lower flange, wherein the gate is locked to the holder when the detent is inserted in the recess, wherein the gate is movable on the holder when the detent is inserted in the recess.

3. The cutter according to claim 2, wherein the cassette includes a spring compressed between the detent and the gate.

4. The cutter according to claim wherein 2, the holder includes a cavity defined in the wall for receiving the blade except the tip.

5. The cutter according to claim 4, wherein the holder includes a stop extending from the upper flange, wherein a portion of the blade is located against the stop while an opposite portion of the blade is located against a wall of the cavity.

6. The cutter according to claim 4, wherein the holder includes a mouth defined by the wall and the lower and upper flanges, wherein the tip of the blade is located outside the holder through the mouth.

7. The cutter according to claim 2, wherein the holder includes a cutout defined in the wall for receiving the button.

8. The cutter according to claim 7, wherein the cassette includes a plate attached to the wall, wherein the plate includes a thickened portion formed thereon and a cutout defined in the thickened portion for receiving the button.

9. The cutter according to claim 8, wherein the cassette includes a spring compressed between the plate and the button.

10. The cutter according to claim 8, wherein the plate includes a rib extending thereon, wherein the gate includes a groove for receiving the rib to ensure smooth sliding of the gate relative to the plate and the holder.

11. The cutter according to claim 1, wherein the clipping unit includes:
a clipping element including two walls between which the space is defined; and
a pusher for pushing the holder to insert the button in a related one of the cutouts.

12. The cutter according to claim 11, wherein the pusher includes an elastic portion located against the holder.

13. The cutter according to claim 12, wherein the pusher includes a slot defined in the elastic portion to enhance the elasticity of the elastic portion.

14. The cutter according to claim 11, wherein the slot and the cutouts are defined in each of the walls of the clipping element.

15. The cutter according to claim 14, wherein the key includes two ends each movable in and along the slot of a related one of the walls of the clipping element and movable into and out of the cutouts of a related one of the walls of the clipping element.

16. The cutter according to claim 11, wherein the handle includes two shells, wherein the clipping element is located between the shells.

17. The cutter according to claim 16, wherein each of the shells includes at least one recess defined therein, wherein the pusher includes at least one boss on each side thereof and inserted in the recess of a related one of the shells.
